(19) United States
(12) Patent Application Publication
(10) Pub. No.: US 2003/0095852 A1
(43) Pub. Date: May 22, 2003

(54) Ribbed dowel

(76) Inventor: Paul Groll, Opalocka, FL (US)

Correspondence Address: Robert M. Schwartz, Esq., Ruden, McClosky, Smith, Schuster & Russell, P.A., 200 East Broward Boulevard, Fort Lauderdale, FL, 33301, US

(21) Appl. No.: 09/996,459

(22) Filed: Nov. 20, 2001

(51) Int. Cl. F16B 15/08

(52) U.S. Cl. 411/452

(57) ABSTRACT

A ribbed dowel for aligning workpieces comprising a cylindrical body having an outer surface, a first end, and a second end; a plurality of ribs spaced over said outer surface; a round circular first face on said first end; a round circular second face on said second end; and wherein the said ribbed dowel is composed substantially of polyethylene.

### TECHNICAL FIELD

The present invention relates generally to a dowel for aligning workpieces. More specifically, the present invention relates to a dowel to align two workpieces or a cabinet wall and a shelf of a cabinet in place, without an adhesive, using a friction fit.

### BACKGROUND OF THE INVENTION

The present invention is a dowel that is used to align two workpieces. Typically, a dowel is inserted into the openings of the two workpieces, previously glue or other adhesive or the friction fit of the dowel within the openings of the workpiece would hold the two workpieces together.

### SUMMARY OF THE INVENTION

This present invention is an improved dowel with longitudinal ribs that is used to align two workpieces or a cabinet wall and a shelf of a cabinet in place, without an adhesive, using a friction fit. Previously, when adhesive was used, the workpieces could not be separated. This provides the advantage of having a knock-down capability, so that the workpieces can be disengaged or knocked down, when desired. Another advantage of the present invention is its improved latitude for tolerance variations providing a

greater ability to adjust for missed tolerances, when the two workpieces are not exactly aligned. In a production line, drilling machines that make the openings to receive the dowels have a tolerance of plus or minus 0.5 mm to where the bore hole is located on the workpiece. When aligning two bores, to receive the same dowel, the error between the center lines of the bore holes can be as much as 1.0 mm, because of the errors in tolerance of the drilling machines in placement of the holes on each opposing workpiece.

In the present invention, the diameter of the bore hole in each workpiece is 0.270 inches. In the event the two workpieces are not aligned center to center, or the holes in each workpiece are not drilled in the right location, the dowel of the present invention can fit in both holes, when the centers of the holes are off as much as 0.070 inches (1.75 mm).

The adjustment the dowel can absorb is equal to twice the height of a rib of the dowel, which is 0.035 inches. This is because the ribs on both sides of the dowel are used, they represent an adjustment of twice 0.035 inches or 0.070 inches. The dowel of the present invention provides a method and apparatus to use a dowel in two workpieces, when the alignments of the bores of the two workpieces are off by

as much as twice the height of the rib on the dowel. The rib height of the dowel is the distance from the base of the rib to the top of the rib.

The rib material is made by Rockwell and is referred to as Rockwell 104 R scale. The material is strong enough to carry substantial weight, but is soft enough to bend and shear. Specifically, the separation or shearing of the rib from the dowel only requires ten (10) pounds of strength. The dowel is capable of supporting a load of 20 pounds.

### DESCRIPTION OF THE DRAWINGS

FIG. 1 is a front-end view of the dowel of the present invention.

FIG. 2 is the top view of the dowel.

FIG. 3 is the rear-end view of the dowel of the present invention.

FIG. 4 is a cross-section of the dowel along lines 4-4 of FIG. 2.

FIG. 5 is a cross sectional view of two workpieces Showing the bores in the respective workpieces where the dowel would be located with the two workpieces aligned.

FIG. 6 is a cross sectional view of two workpieces showing the bores in the respective workpieces where the dowel would be located when the two workpieces are not aligned.

FIG. 7 is a cross sectional view of two workpieces showing the bores in the respective workpieces where the two workpieces are aligned and with the dowel in place.

FIG. 8 is a cross sectional view of two workpieces showing the bores in the respective workpieces where the two workpieces not aligned by the distance of the height of one rib and with the dowel in place.

FIG. 9 is an enlargement of the dowel and partial view of the surrounding workpieces of FIG. 8.

FIG. 10 is an enlargement of the circled portion of FIG. 9.

FIG. 11 is a cross sectional view of the two workpieces not aligned with the dowel in place.

### DESCRIPTION OF ILLUSTRATIVE PREFERRED EMBODIMENTS

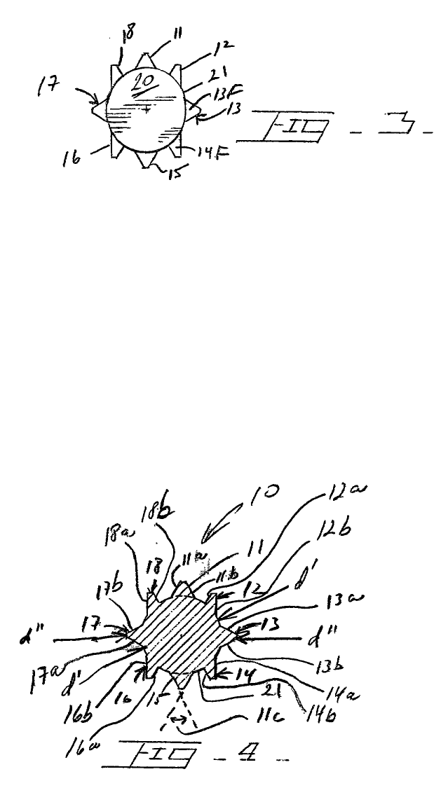

Referring to FIG. 2, dowel 10 of the present invention, has an elongated cylindrical body with a length greater than its diameter. Dowel 10 is shaped to have a plurality of ribs 11, 12, 13, 14, 15, 16, 17 and 18. It can be noted that pairs of said ribs are spaced on opposite sides of cylindrical dowel 10. Thus, ribs 11 and 15 form a first pair of opposed ribs, ribs 13 and 17 form a second pair of opposed ribs, ribs 14 and 18 form a third pair of opposed ribs, and ribs 12 and 16 form a fourth pair of opposed ribs. Dowel 10 therefore, has a first outside diameter d′ which is measured at locations on the dowel where there are no ribs and a second outside diameter d″, measured at a location on the dowel where there are opposed pairs of ribs. The overall outside diameter of d′ of the preferred embodiment is 0.200 inches and the overall outside diameter d″ is 0.270 inches. Thus, the outside diameter measured at each pair of ribs is approximately 0.270 inches, and the outside diameter at each of the valleys between the adjacent ribs is 0.200 inches. It can also be seen that pairs of ribs have different shapes. Ribs 11 and 15 are generally triangular in shape, with sidewalls 11a and 11b forming an angle 11c of 60°. Again, being noted that opposed ribs 11 and 15 are complimentary and identical in shape. Likewise, ribs 13 and 17 are complimentary and identical, having walls 17a and 17b and 13a and 13b that each form an angle of 60°. Thus, ribs 13 and 17 have side walls 13a and 13b that form an angle of 60°.

Likewise, opposed ribs 12 and 16 and 14 and 18 have complementary and identical shapes. As seen in FIG. 4 ribs 16 and 12 have vertical side walls 16b and 12b respectively and shorter angled side walls 16a and 12a respectively.

Likewise ribs 14 and 18 have complementary and identical shapes. As seen in FIG. 4 ribs 14 and 18 have vertical side walls 14a and 18a respectively and shorter angled side walls 14b and 18b respectively.

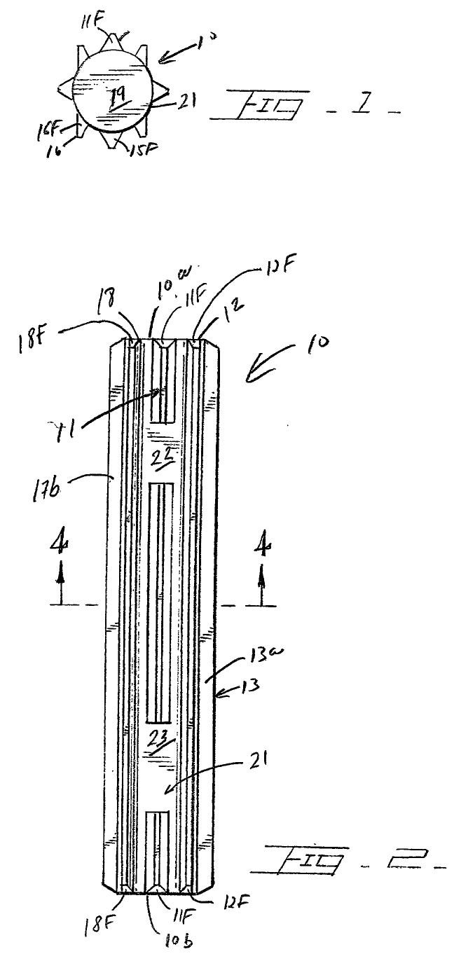

Referring to FIG. 1, it can be seen that dowel 10 includes a front face having a circular perimeter corresponding to diameter d′, a round circular face 19 and an opposite round circular face 20 (FIG. 3), at the opposite end of dowel 10. The outside perimeter portion of faces 19 and 20 correspond to diameter d′.

Referring to FIG. 2, it can be seen that each rib has a tapered front and rear face that is slanted towards the center of dowel 10 from the intersection of each respective round face 19 and 20. Each said tapered face is marked with a corresponding letter F, e.g., 11 through 18. It being noted that both ends of dowel 10 are substantially identically. Thus, each rib at each end has a tapered face that intersects with and meets the respective round face 19 or 20.

Rib 11 differs from the other ribs in that it is not contiguous along its length. Rib 11 has two gaps. A first gap 22 and a second gap 23. These gaps as is known in the art, allow the ejector pin in the rolling process to avoid the spick ejector pin in the manufacturing process.

The dowel of the present invention is made of a high impact strength polypropylene material. Different polymers have different properties as a result of the differences in their chemical structure. Thus, some polymers are better suited for some applications than are others, by design. High-density polyethylene (HDPE) is an economical, lightweight thermoplastic with characteristics including excellent chemical resistance, low moisture absorption, good impact strength, excellent low-temperature properties, low coefficient of friction, and abrasion resistance. Formulations include: sheet, rod and tube. Ultra high molecular weight polyethylene (UHMWPE) has extremely high abrasion resistance when compared to other thermoplastics. It also has exceptional impact resistance, even at cryogenic temperatures, and is superior to stainless steel. Other advantages include: low moisture absorption, good electrical and thermal insulation, self-lubrication and chemical inertness (except in some acids). Formulations include: sheet, rod and tube. As will be seen, the qualities of the high-density and the ultra high molecular weight polyethylenes form a dowel that is sufficiently rigid and suitably flexible over other polymers, such as polypropylene, in order to allow the ribs to flex and/or shear off when dowel is inserted into bore holes in workpieces.

Prior to the present invention, polypropylene was utilized by the applicant as the sole component of the dowel. Polypropylene is similar to polyethylene, but incorporates a methyl group. The crystalline nature of polypropylene results in a post-molded article that is not dimensionally stable until full crystallization has taken place. This can take up to 24 hours and involve significant movement in the article. Moreover, the polypropylene dowel lacked the requisite rigidity required for the application of the dowel to align workpieces. Thus, polypropylene is unsuitable as a sole or primary component of the dowel.

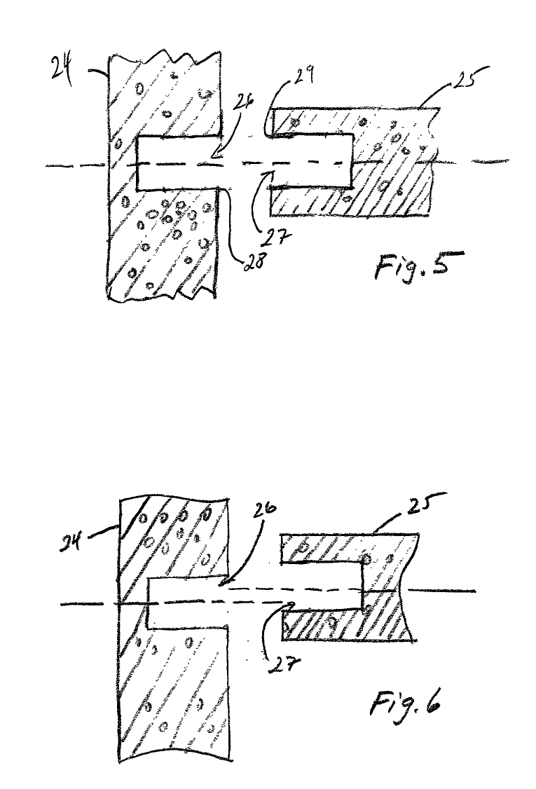

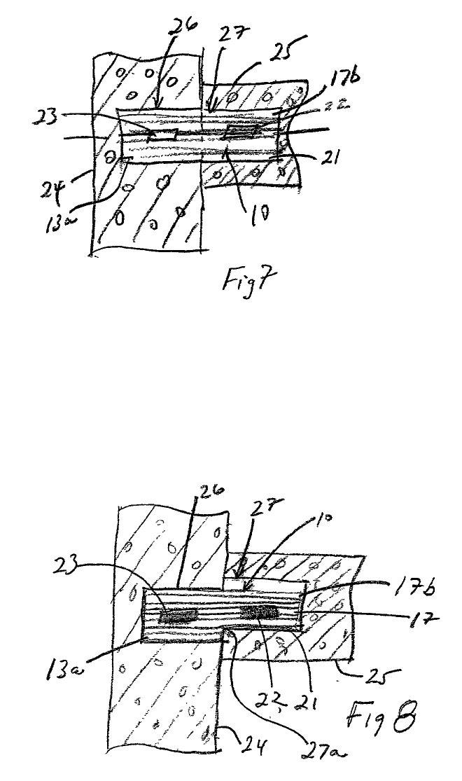

The dowel 10 is used in combination with workpieces that are to be joined. Referring to FIG. 5, a first workpiece 24 may be a vertical wall of a cabinet. Workpiece 25 may be, for example, a horizontal shelf of a cabinet. Each workpiece will have one or more openings; bore holes to receive a dowel 10. As shown in FIG. 5, wall 24 has a board opening bore hole 26 and shelf 25 has a board opening bore hole 27. The drilling of bore holes 26 and 27 is well known in the art. The workpieces 24 and 25 are generally made of particle board with a plastic veneer melamine finish or vinyl finish. Though the workpieces can be of any material wood or plastic that is finished or unfinished. Typically, wall 24 will have a thickness of 5/8 inch to 3/4 inch and typically, shelf 25 will have a thickness of 5/8 inch or 3/4 inch. The perimeter outside edges 28 and 29 of each bore hole 26 and 27 respectively are sharp and act like a cutting edge.

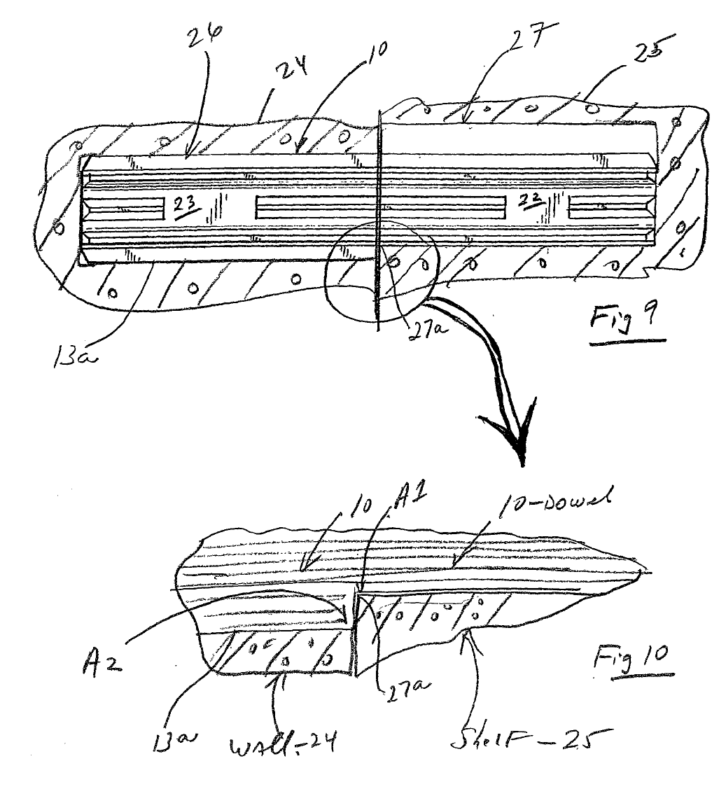

During the manufacturing process, it will be desired to join a shelf 25 to a wall 24. Critical will be the alignment of prebored holes 26 and 27 in the respective workpiece. The bore holes 26 and 27 are predrilled to be located in a certain location according to a certain plan with manufacturing tolerances. Preferably the bore holes 26 and 27 will be in alignment as shown in FIG. 5. In this instance a first end 10a of dowel 10, during the manufacturing process, is inserted into a first bore opening 26 of a first workpiece 24. During manufacturing, a second workpiece 25 is aligned with the first workpiece 24 and the two workpieces are urged closer until they are in a desired mated relationship. In this instance, as shown in FIG. 7 a shelf workpiece 25 abuts a wall workpiece 24. If the bore holes 26 and 27 within said workpieces 24 and 25 respectively are properly drilled, then the two bore holes, 26 and 27 will be in alignment and dowel 10 will fit within both said bore holes 26 and 27.

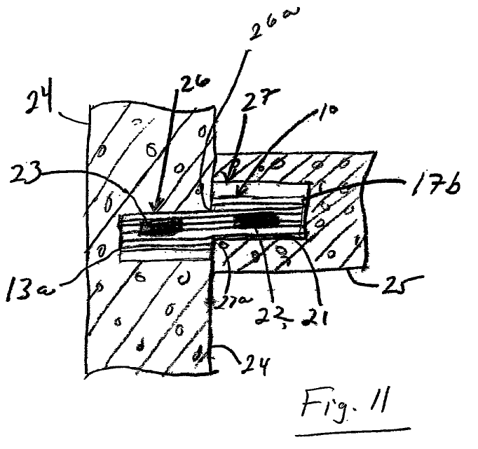

However, if the tolerance of the bore holes 26 and 27 are such that they are not in alignment, either because of the tolerances of the drilling of said bore holes 26 and 27 or because of the alignment of the two workpieces 24 and 25, then the two bore hole 26 and 27 will not be or would not be in alignment. In this instance, the alignment will be as in FIGS. 6 and 8.

FIG. 6 shows the bore holes 26 and 27 not in alignment and FIG. 8 shows the dowel 10 of the present invention, as it is intended to work within the two bore holes 26 and 27 where workpieces 24 and 25 are in a butted relationship with an end of one workpiece 25 against the planar wall of the second workpiece 24.

Referring to FIG. 8, dowel 10 is shown as the top view seen in FIG. 2. Since dowel 10 is cylindrical, any portion of dowel 10 could have been seen. Of particular interest, rib 17 extends the entire length of dowel 10. Rib 13(a) only extends the approximate length of bore hole 26 because the balance of rib 13 has been either (sheared) shaved of f; or flattened within bore hole 27 or within bore hole 26 or both.

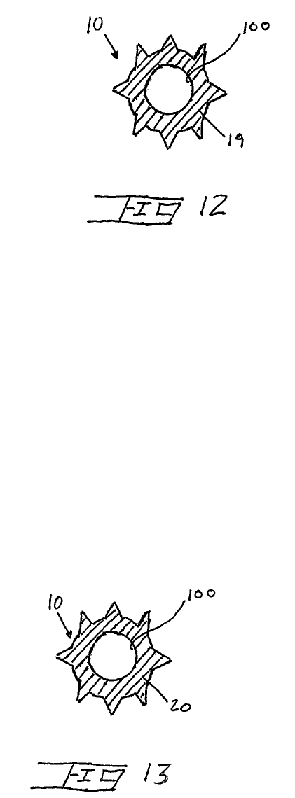

Referring to FIG. 9, it is an enlargement of FIG. 8. FIG. 10 is a further enlargement of the circled portion of FIG. 9. As can be seen in FIG. 9 a portion of rib 13a within opening 27 has been sheared off or has been compressed within bore hole 27. The shearing of the rib, which is cut by the opening edge of hole 27a, will allow the remaining portions of dowel 10 to fit within the inside perimeter of opening 27. Therefore, rib 13 in FIG. 9 would only extend along the portion of dowel 10 that is in hole 26. Because the holes 26 and 27 in FIG. 9 are offset when the dowel was placed into workpieces 25 and 26, rib 13 would have been compressed, shaved or peeled. This shaved portion or thread not shown on the drawings would be further compressed if shaved off by the pressure between the two workpieces 24 and 25 or by the pressure of dowel 10 against the inside walls of bore holes 26 or 27 or both.

It is also believed, that dowel 10 may shift longitudinally causing corner 27a to dig into rib 13. This digging at the corner 27a increases the rigidity of dowel 10 within the holes 26 and 29.

As just seen in displayed FIGS. 8, 9 and 10 the alignment of the openings 26 and 27 is off or one opening is displaced from the other by the distance of the height of a single rib.

Referring to FIG. 11 is an example where the alignment of the two bore holes 26 and 27 is off by the height of two ribs.

In FIG. 11 the arrangement is such that a portion of rib 17b does not extend into opening 26. Likewise a portion of 13a does not extend into opening 27. Likewise dowel 10 rotates about its central longitudinal axis so that the corners of the respective pieces 27a of workpiece 25 and the corner 26a of workpiece 24 would dig into dowel 10 providing extra support for the dowel within the two opposed openings. Adjacent rib portion 17b is a space within opening 27. Likewise adjacent rib portion 13a is a space within opening 26.

In an alternative embodiment, illustrated in FIGS. 12 and 13, the cylindrical dowel 10 includes a longitudinal bore 100 extending from round circular face 19 to opposite round circular face 20. Longitudinal bore 100 serves to hollow out cylindrical dowel 10, resulting in less polyethylene material being used in forming dowel 10.

In summary the present invention is an improved dowel having one or more pairs of opposed ribs. The material of the dowel is such that the longitudinal shear strength of the dowel portion at the joint of a rib at the circumference of the dowel is less than the load strength of the dowel, by a factor of 2 to 1. The height of each rib is approximately 15% the diameter of the dowel without the ribs. Since the rib can be sheared off the amount of distance of adjustability for tolerances that the rib can adjust for is twice the height of a rib.

While only a few embodiments of the present invention have been described in detail above, those skilled in the art will readily appreciate that numerous modifications to the exemplary embodiments are possible without materially departing from the novel teachings and advantages of this invention. Accordingly, all such modifications are intended to be included within the scope of this invention as defined in the following claims.

What is claimed is:

1. A ribbed dowel for aligning workpieces comprising:
a cylindrical body having an outer surface, a first end, and a second end;
a plurality of ribs spaced over said outer surface;
a round circular first face on said first end;
a round circular second face on said second end; and wherein the said ribbed dowel is composed substantially of polyethylene.

2. The ribbed dowel according to claim 1 wherein said cylindrical body includes a longitudinal bore extending from said round circular first face to said round circular second face.

3. The ribbed dowel according to claim 1 wherein said ribs include a tapered front face.

4. The ribbed dowel according to claim 3 wherein said ribs include a tapered rear face.

5. The ribbed dowel according to claim 4 wherein said tapered front face intersects with and meets said round circular first face.

6. The ribbed dowel according to claim 5 wherein said tapered rear face intersects with and meets said round circular second face.

7. The ribbed dowel according to claim 6 wherein at least one rib of said plurality of ribs is sheared or shaved.

8. The ribbed dowel according to claim 6 wherein at least one rib of said plurality of ribs is compressed.

9. The ribbed dowel according to claim 1 wherein said polyethylene is a high-density polyethylene.

10. The ribbed dowel according to claim 1 wherein said polyethylene is an ultra high molecular weight polyethylene.

11. A method of aligning workpieces, said method comprising the steps of:
inserting a ribbed dowel having a plurality of ribs and composed substantially of polyethylene into a bore hole of a first workpiece;
inserting said ribbed dowel into a bore hole of a second workpiece; and
placing said first workpiece and said second workpiece in a butted relationship, wherein at least one rib of said plurality of ribs is structurally altered within said bore hole of said first workpiece or within said bore hole of said second workpiece.

12. The method according to claim 11 wherein said ribs include a tapered front face.

13. The method according to claim 12 wherein said ribs include a tapered rear face.

14. The method according to claim 11 wherein said polyethylene is a high-density polyethylene.

15. The method according to claim 11 wherein said polyethylene is an ultra high molecular weight polyethylene.

16. The method according to claim 11 wherein at least one rib of said plurality of ribs is structurally altered through shearing or shaving.

17. The method according to claim 11 wherein at least one rib of said plurality of ribs is structurally altered through compression.

18. A ribbed dowel for aligning workpieces comprising:
a cylindrical body having an outer surface, a first end, and a second end;
a plurality of ribs spaced over said outer surface;
a round circular first face on said first end;
a round circular second face on said second end; and wherein said ribbed dowel consists essentially of polyethylene.

19. The ribbed dowel according to claim 18 wherein said cylindrical body includes a longitudinal bore extending from said round circular first face to said round circular second face.

20. The ribbed dowel according to claim 18 wherein said ribs include a tapered front face.

21. The ribbed dowel according to claim 20 wherein said ribs include a tapered rear face.

22. The ribbed dowel according to claim 21 wherein said tapered front face intersects with and meets said round circular first face.

23. The ribbed dowel according to claim 22 wherein said tapered rear face intersects with and meets said round circular second face.

24. The ribbed dowel according to claim 23 wherein at least one rib of said plurality of ribs is sheared or shaved.

25. The ribbed dowel according to claim 23 wherein at least one rib of said plurality of ribs is compressed.

26. The ribbed dowel according to claim 18 wherein said polyethylene is a high-density polyethylene.

27. The ribbed dowel according to claim 18 wherein said polyethylene is an ultra high molecular weight polyethylene.
